(19) United States
(12) Patent Application Publication
(10) Pub. No.: US 2026/0056914 A1
(43) Pub. Date: Feb. 26, 2026

(54) Data Analysis and Data Forensics System and Method

(71) Applicant: Jared Ringenberg, Huntington, IN (US)

(72) Inventor: Jared Ringenberg, Huntington, IN (US)

(21) Appl. No.: 19/283,582

(22) Filed: Jul. 29, 2025

Related U.S. Application Data
(63) Continuation of application No. 18/017,398, now abandoned.
(60) Provisional application No. 63/055,120, filed on Jul. 22, 2020.

(51) Int. Cl. G06F 16/11

(52) U.S. Cl. CPC G06F 16/113

(57) ABSTRACT

A data analysis method includes assessing a source memory device by an intermediate computing device, copying data from the source memory device to a destination memory device, copying data from the source memory device to the intermediate computing device, monitoring the copying of the data to the intermediate device to determine if partitions can be read, based on if the partitions can be read, monitoring the copying of the data to the intermediate device to determine if an end of a file can be read and based on if the end of a file can be read, extracting files of interest from the data copied onto the intermediate device.

### RELATED APPLICATIONS/CLAIM FOR PRIORITY

This application is a continuation of pending U.S. application Ser. No. 18/017,398 filed on 21 Jan. 2023 which is a national stage application of PCT/US2021/042858 filed on Jul. 22, 2021 that claims the benefit of the filing date of U.S. Provisional Application No. 63/055,120 filed on Jul. 22, 2020. The subject matter of each of these applications are incorporated in their entirety herein by reference.

### BACKGROUND

The present disclosure is directed to data forensics and more particularly to analyzing data files while simultaneously archiving the data.

Analyzing data from computer media including internal, external or standalone memory devices is known. Data may be analyzed for many reasons including, but not limited to, completion (ensuring a complete copy of data is present) and error detection for example. Data may also be analyzed for forensic purposes such as for gathering incriminating evidence in a criminal proceeding including terrorism related investigations.

The traditional analysis included analyzing the data while it is on the source device. Analysis also included copying the data from the source device to a destination device and then analyzing data on the destination device.

In some situations, it is desirable to have the ability to analyze and flag the data in a more expedient manner.

### SUMMARY

According to an example embodiment, a data analysis method is disclosed. The method comprises: assessing a source memory device by an intermediate computing device; copying data from the source memory device to a destination memory device; copying data from the source memory device to the intermediate computing device; monitoring the copying of the data to the intermediate device to determine if partitions can be read; based on if the partitions can be read, monitoring the copying of the data to the intermediate device to determine if an end of a file can be read; and based on if the end of a file can be read, extracting files of interest from the data copied onto the intermediate device.

According to another example embodiment, a system for analyzing data is disclosed. The system comprises: a source memory device including a plurality of data files; an intermediate computing device communicatively coupled to the source memory device; and a destination memory device communicatively coupled to the intermediate computing device, wherein the intermediate computing device: assesses a structure of the source memory device;

initiates a copying of the data from the source memory device to the destination memory device; and initiates a copying of the data from the source memory device to the intermediate computing device concurrently with the copying of the data to the destination computing device.

### BRIEF DESCRIPTION OF THE DRAWINGS

The several features, objects, and advantages of exemplary embodiments will be understood by reading this description in conjunction with the drawings. The same reference numbers in different drawings identify the same or similar elements. In the drawings:

FIG. 1 illustrates a source storage device;

FIG. 2 illustrates a system in accordance with example embodiments;

FIG. 3 illustrates a source memory device for assessment by an intermediate computing device according to an example embodiment;

FIG. 4 illustrates transfer of data from the source memory device to the intermediate computing device according to an example embodiment;

FIG. 5 illustrates a reading of a partition of data copied from the source memory device to the intermediate computing device according to an example embodiment;

FIG. 6 illustrates reading of an end of file from the source memory device to the intermediate computing device according to an example embodiment;

FIG. 7 illustrates completion of extraction of files from data transferred to the intermediate computing device according to an example embodiment;

FIG. 8 illustrates a distributed system for extraction of files from data transferred to the intermediate computing device according to an example embodiment;

FIG. 9 illustrates a method in accordance with example embodiments; and

FIG. 10 illustrates an intermediate computing device of files from data transferred to the intermediate computing device according to an example embodiment.

### DETAILED DESCRIPTION

In the following description, numerous specific details are given to provide a thorough understanding of embodiments. The embodiments can be practiced without one or more of the specific details, or with other methods, components, materials, etc. In other instances, well-known structures, materials, or operations are not shown or described in detail to avoid obscuring aspects of the exemplary embodiments.

Reference throughout this specification to an “example embodiment” or “example embodiments” means that a particular feature, structure, or characteristic as described is included in at least one embodiment. Thus, the appearances of these terms and similar phrases in various places throughout this specification are not necessarily all referring to the same embodiment.

Furthermore, the particular features, structures, or characteristics may be combined in any suitable manner in one or more embodiments. The headings provided herein are for convenience only and do not interpret the scope or meaning of the embodiments.

Example embodiments disclose a novel method and system for analyzing and flagging data from a memory (or storage) device while simultaneously and securely archiving a full copy of the data from the memory device.

The memory device may be an internal or external hard drive of a computing device for example. The memory device may also be a cloud server location accessible over a private or a public network. In some embodiments, the memory device may also be a network accessible storage device. Other types of memory devices and locations in which data may be stored can be utilized for analyzing the stored data according to example embodiments. The memory device can also be associated with a processor, a user interface and a communication interface such as a network interface including, but not limited to, a modem, a communication cable, etc.

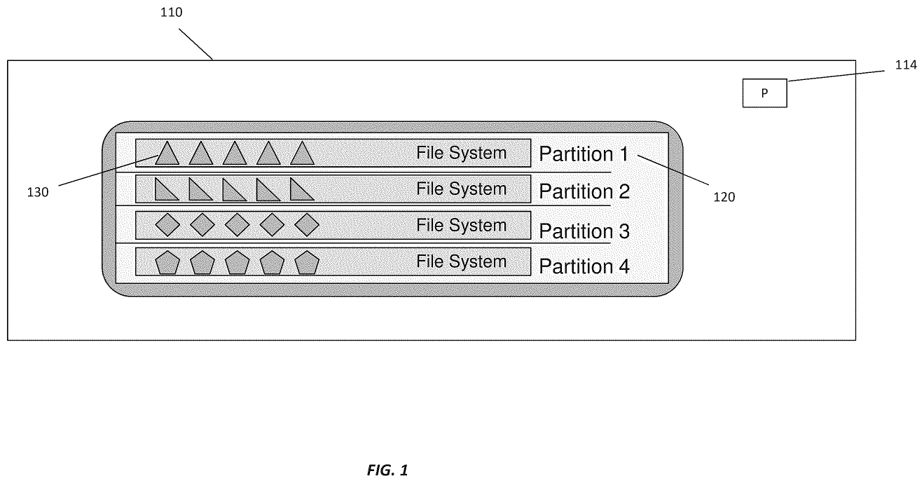

An example memory (or storage) device 110 is illustrated in FIG. 1. The memory device may include a plurality of partitions 120 (4 in this case) each having a number of data files 130 (5 in this case) for a total of twenty (20) files. The data files within each partition may be organized according to a file system. File systems may include, but are not limited to, Windows NTFS, Windows FAT32 and Linux Ext3 for example. Memory device 110 may be viewed as a “source” memory device since the data of interest is stored in this device. Source memory device 110 may be a memory that is part of, or associated with, or accessible to, a user computer. Source memory device can include a processor (P) 118 and other known components such as a modem, a graphic card, etc.

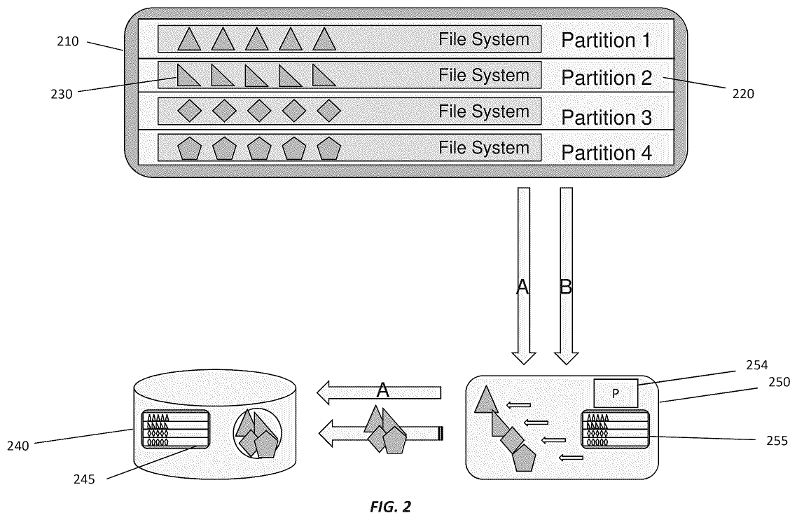

A copy of the data in source memory device may be made onto another memory device which may be referred to as “destination” memory device. Such a copy may be made in response to instructions from an intermediate computing device. As illustrated in FIG. 2, the data 230 within partitions 220 of source memory device 210 (i.e. all of the files in all of the partitions) may be copied onto destination memory device 240 via path “A” in its entirety (i.e. all the data in source memory device 210).

The intermediate computing device 250 may access source memory device 210 and assess the structure and contents of the source memory device. Intermediate computing device may also apply a set of specified criteria to detect files within the source memory device that are of interest. The intermediate computing device may then provide instructions for copying data from the source memory device 210 to the destination memory device 240. The data being copied in entirety from the source memory device to the destination memory device “passes thru”the intermediate computing device.

Intermediate computing device may include, but is not limited to, a laptop, a desktop, a tablet, or a dedicated computing device having the ability to connect to both the source storage device and destination storage device. In some embodiments, both the intermediate computing device and the destination storage device may be implemented as one physical device having the ability to be connected to a source storage device. The connection between the intermediate computing device and the source storage device may be a physical connection. The connection may also be a wireless or remote connection.

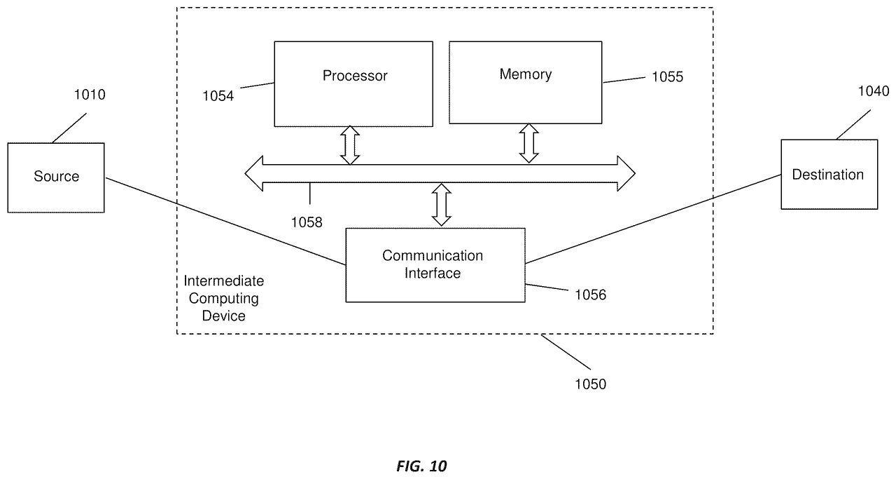

The intermediate computing device may include one or more processors, one or more memories, one or more communication/connection interfaces and one or more buses for interconnecting each of the components included within the intermediate computing device. An example intermediate computing device is illustrated and further described below with reference to FIG. 10.

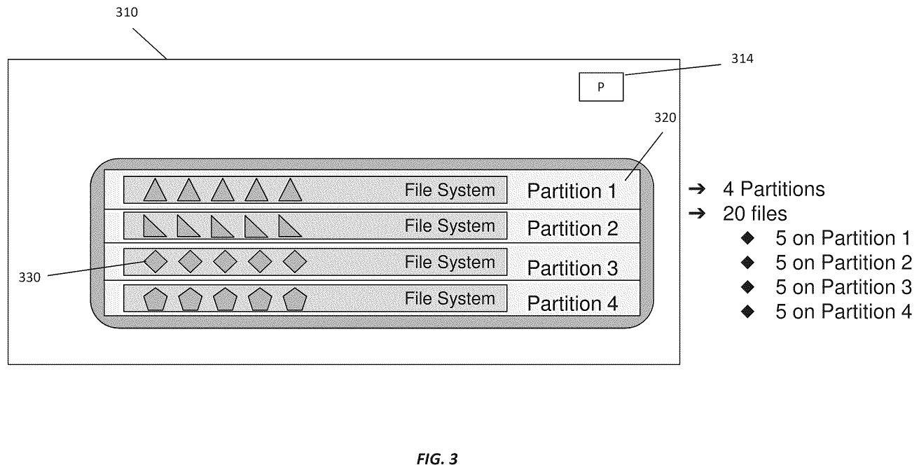

Referring to FIG. 3, processor 254 may, for example, assess the source memory device 310 to determine the structure of the source memory device. The structure of the memory device may be the memory partitions within the memory device.

The assessment may include determining how the data is structured within the storage device. The partition table, the file systems on those partitions and the files within the file systems may be evaluated. Any memory space outside of the partition table may also be evaluated to identify unused memory or differently structured memory (such as malware hiding data in unused space outside of the primary partition table for example).

Processor 254 may identify the files of interest and the memory address(es) corresponding to the files of interest in the source memory device.

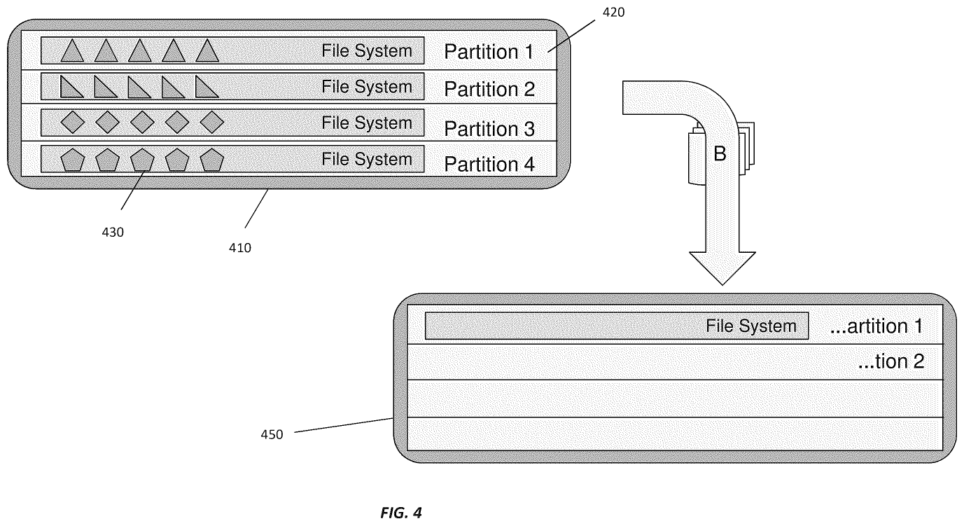

Referring to FIG. 4, upon completion of the assessment of the source memory device 410 and identification of files of interest 430 and their associated memory address, and concurrent (i.e. simultaneous) to the copying of data from source memory device to the destination memory device, data from source memory device may be copied onto intermediate computing device 450. As described above, the intermediate computing device may include at least one memory (memory 254 of intermediate computing device 250 in FIG. 2).

As the size of the data being copied increases/grows in intermediate computing device 450, the copying of each partition may be monitored by intermediate computing device 450 and a determination may be made as to whether or when the intermediate computing device 450 can read the partitions (or partition table). This evaluation may take place as data is being copied from source memory device 410 to intermediate computing device 450. The entire data from the source memory device need not be copied onto memory of the intermediate computing device in order to determine whether the partitions can be read.

Intermediate computing device 450 performs an assessment process that progressively reads a live acquisition or duplication and extracts data prior to duplication completion.

The partitions may be copied sequentially in some embodiments. In other embodiments, they may be copied based on an assigned level of importance or size for example.

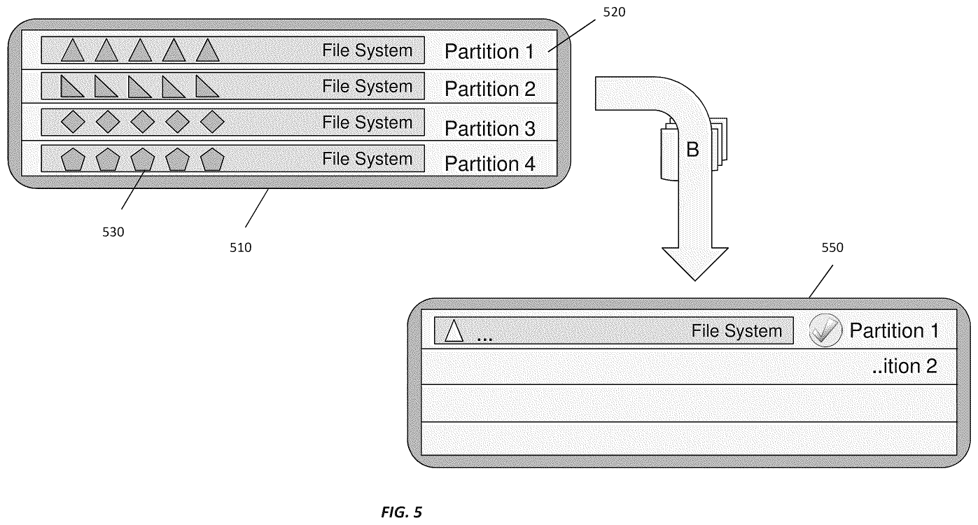

As illustrated in FIG. 5, if the partitions can be read by the intermediate computing device (i.e. a partition becomes readable), the intermediate computing device may assess whether an end of file for a file of interest has been copied and can be read by the intermediate computing device. The address identified during assessment of the source memory device may be utilized to read the last bytes of the file (of interest). The file system associated with the data being copied onto intermediate computing device 550 may be assessed multiple times during acquisition progress to check for additional data accessibility.

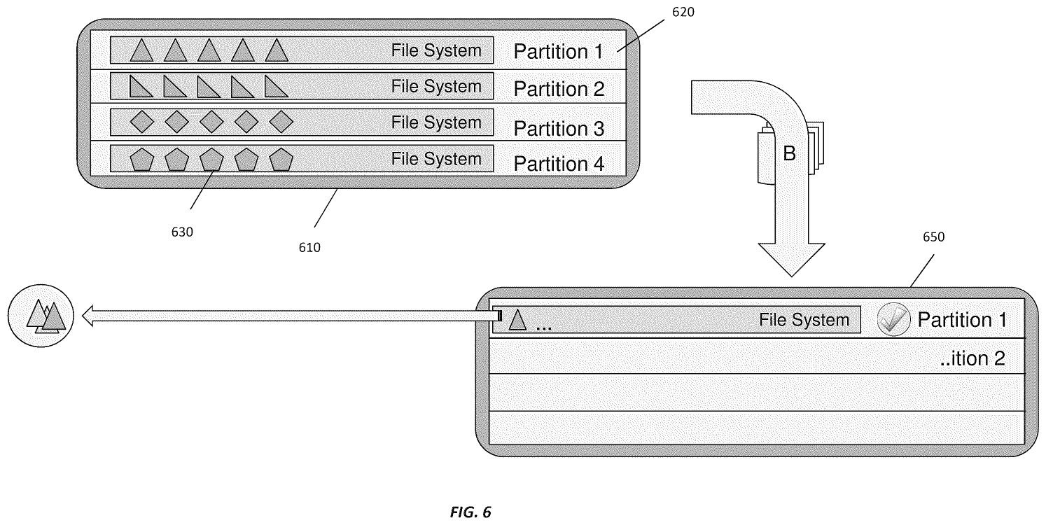

Referring to FIG. 6, once the end of the file (i.e. the last byte of the file) can be read, the corresponding file may be extracted. The extracted file may then be sent to a pre-determined memory device (such as destination memory device 240 for example).

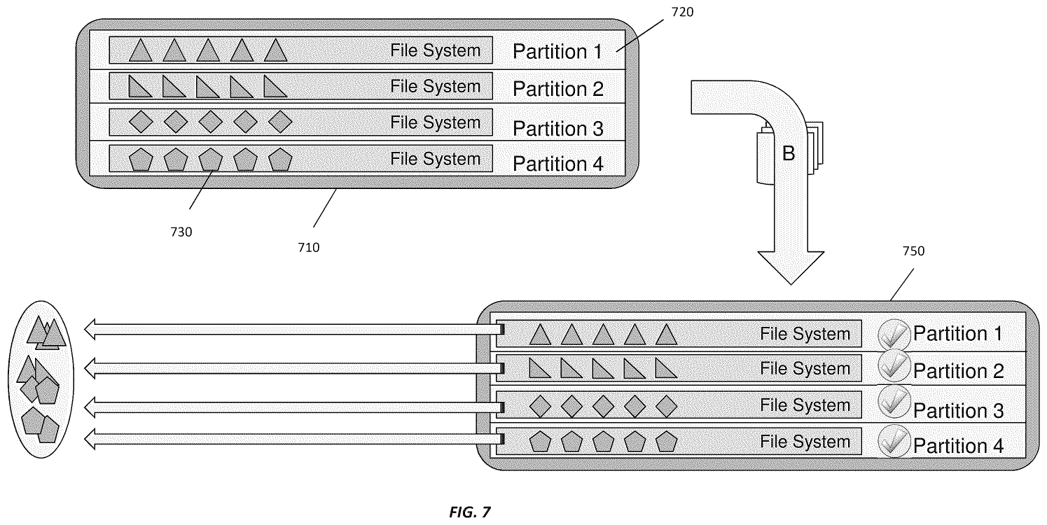

As illustrated in FIG. 7, the assessment of partitions and extraction of data described above may be repeated by intermediate computing device 750 for partitions 720 and data 730 in source memory device 710 until all files of interest within device 710 have been copied onto intermediate computing device 750 and analyzed and extracted by the intermediate computing device. The extracted files may be sent to a memory device. The destination memory device can receive these files in some embodiments.

As described above, the assessment and extraction may occur concurrently while the entire data in the source memory device is being copied onto destination memory device.

While the two paths “A” and “B” are illustrated as leading to two separate devices locations (in FIG. 2), both paths can also lead to one physical device in some embodiments. The one physical device can have one or more processors.

While the description above has identified an intermediate computing device, in some example embodiments, multiple intermediate computing devices may be implemented.

Multiple intermediate computing devices may result in reducing the time needed to analyze and extract the files of interest.

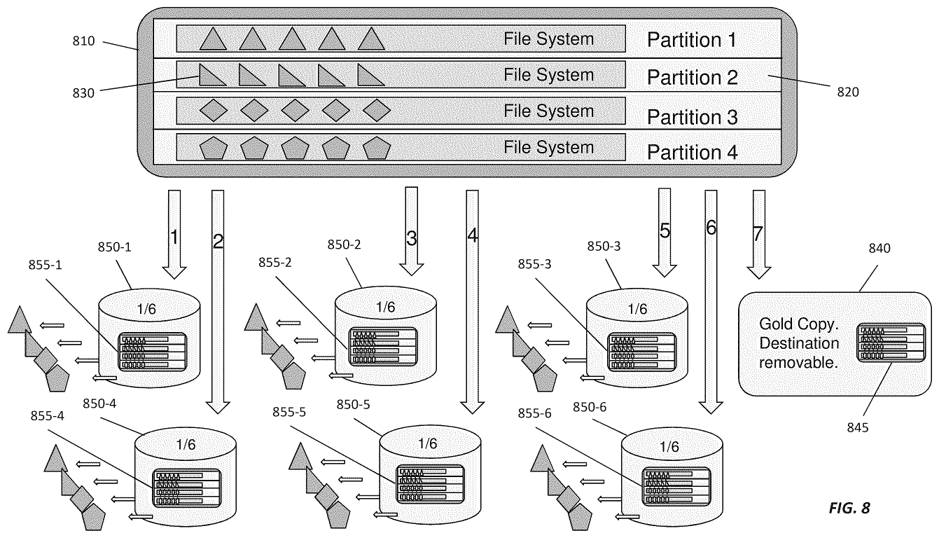

The data from source memory device 110 of FIG. 1 may be assessed and extracted in/by a plurality of intermediate computing devices having a processing capacity. As illustrated in FIG. 8, a copy of the data from the source memory device 810 may be copied onto destination memory device 840 via path “7” which may correspond to path “A” of FIG. 2.

The data from source memory device 810 may be divided into a plurality of portions. Each of the portions may be “assigned” to a particular intermediate computing device. In the illustrated example, six (6) such intermediate computing devices 850-1 to 850-6 are included. A plurality of paths 1-6, corresponding to path “B” of FIGS. 2 and 4-7 may connect the source memory device to an associated intermediate computing device.

In an example embodiment, each of the plurality of intermediate computing devices 850-1 to 850-6 may assess the structure of the source computing device and a complete copy of the data from source memory device may simultaneously be sent to each of the plurality of intermediate computing devices. Each intermediate computing device may extract the files of interest included in its assigned portion of memory.

The plurality of intermediate computing devices may be arranged in a network storage array. One of the plurality of intermediate computing devices may be designated as a primary or supervisory intermediate computing device. The primary intermediate computing device may assess the source memory device and provide instructions to the remaining intermediate computing devices for file extraction, etc. Path “A” may “pass thru” the primary intermediate computing device in some embodiments. Path “A” may “pass thru” one of the plurality of intermediate computing devices.

The plurality may be determined by the number of available intermediate computing devices. Upon assessment, the list of files of interest and processing instructions may be sent to each of the corresponding intermediate computing devices. If two intermediate computing devices are available and the number of files of interest in partition one (1) is ten (10), then this number may be divided by the number of intermediate computing devices.

Each of the intermediate computing devices may be assigned to extract five of the ten files of interest. As highlighted above, each of the intermediate computing devices may receive a complete copy of the data from the source memory device. This process may be repeated for each of the other partitions on the source memory device. Other methods of dividing the total number of files of interest may be implemented based on other factors such as a size of the file for example.

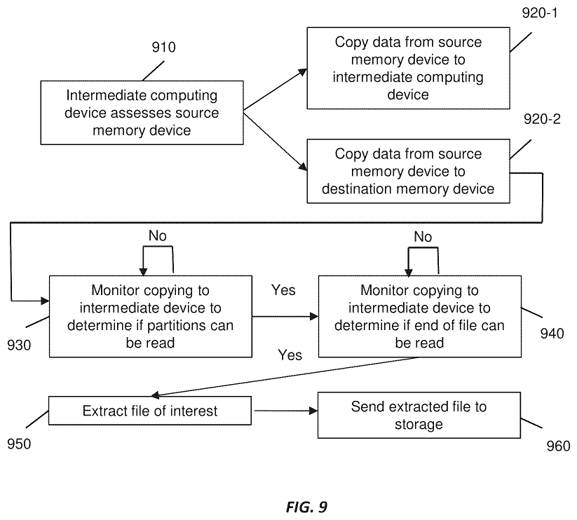

A method in accordance with example embodiments is illustrated in FIG. 9. An intermediate computing device may assess the source memory device at 910. Data from the source memory device may be copied (in its entirety) onto a memory associated with the intermediate computing device at 920-1. Concurrently, data from the from the source memory device may be copied (in its entirety) onto a destination memory device at 920-2.

The intermediate computing device may monitor the copying of the data to determine if partitions of the memory being copied can be read at 930. If the partition cannot be read, the monitoring of the copying may continue. If the partition can be read, the intermediate computing device may determine whether an end of file of a file of interest has been copied at 940. If the end of file has not been copied, the copying continues. If the end of file has been copied, the file of interest may be extracted at 950. The extracted files of interest may be sent to a memory device such as destination memory device at 960.

In the Figures, reference numerals 120, 220,. 720 and 820 can refer to any one or more of the partitions. Similarly, reference numerals 130, 230, . . . 730 and 830 can refer to any of the data files (regardless of the representative shape illustrated).

An example intermediate computing device, such as device 1050, is illustrated in FIG. 10. Device 1050 may comprise one or more processors 1054, one more memories 1055, a communication interface 1056 and a system bus 1058 for interconnecting the various components of the intermediate computing device. Intermediate computing device may be connected to a source memory device 1010 and a destination memory device 1040.

The extracted data may be utilized to monitor and/or restrict user activity online or take preventive and/or punitive action based on the nature or substance of the data.

In some embodiments, executable instructions encoded in a computer readable medium when executed on a computing device may perform the method steps as described above.

The hardware of the intermediate computing device (in this case ATRIO) may be running a modern mobile processor platform such as the Intel Tiger Lake CPU for example. The internal memory may be a 8Tb NVMe M.2 memory stick with 64 Gb of RAM for example. The hardware specification is subject to change depending on the platform on which the software is run. The software can be scaled to a larger workstation level system as well as server platforms and smaller pocket-sized devices.

The software can create two forensic images, one on the destination memory device and one on the internal NVMe memory of the intermediate computing device. The software may actively monitor the progress of the internal NVMe copy. When the intermediate computing device is able to read the partition table, the computing device attempts to read the file system of the first partition.

When the intermediate computing system is able to read the file system, an attempt will be made to read the last few bytes of the file that is of interest and that is to be extracted. Once the end of the file that is of interest in extracting is read, that file is copied to the destination drive. The process as described is being performed as the acquisition is progressing (i.e. data is being copied to the intermediate computing device), causing the exploitation and acquisition to happen simultaneously.

In some instances, the file system may be read in full on the source device by the intermediate computing device. In such a scenario, the intermediate computing device will analyze the results, identify data of interest, and then attempt to extract the files by reading the end of the file in the file system on the partition of interest.

Once all files of interest have been copied, the intermediate computing device may begin checking to see if the partition has been fully copied by attempting to read the end of the partition. If the intermediate computing device is able to read the end of the partition, additional processes may be run against the full partition copy. The intermediate computing device may then process the next partition and repeat the process.

In other instances, when it is necessary to progressively read the file system on the intermediate computing device due to time constraints, the intermediate computing device may analyze the files progressively on the intermediate computing device rather than the source device. As the copy of the data increases in size and the partition table can be read, the intermediate computing device may attempt to read the file system on a partition that is being targeted.

The initial read of the file system may not be a complete listing due to the progressive nature of the increasing/growing copy. As a result, once the intermediate computing device is able to read the file system in part, it will then analyze the file system results and identify key data of interest. It will then begin to attempt to extract the files by reading the end of the file it is targeting. Once the intermediate computing device has read the end of the file, the file may be extracted and the next file or dataset of interest may be processed. Once the intermediate computing device processes all of the files of interest, the intermediate computing device may periodically check the file system for additional entries as well as checking to determine if the partition has been fully copied.

The intermediate computing device determines the partition has been fully copied by attempting to read the end of the partition. If the intermediate computing device is able to read the last few bytes of the partition, another file system listing may be run and then the intermediate computing device further process any remaining files that might have identified.

The intermediate computing device may then run additional processes against the completed partition and then move on to the next partition to begin the progressing extraction and assessment of that partition. This process may be repeated until every partition has been copied and every file identified and extracted.

Although exemplary embodiments have been disclosed, it will be apparent to those skilled in the art that various changes and modifications can be made which will achieve some of the advantages of embodiments without departing from the spirit and scope of the disclosure. Such modifications are intended to be covered by the appended claims.

Further, in the description and the appended claims the meaning of “comprising” is not to be understood as excluding other elements or steps. Further, “a” or “an” does not exclude a plurality, and a single unit may fulfill the functions of several means recited in the claims.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in relevant art.

The various embodiments described above can be combined to provide further embodiments. Aspects of the embodiments can be modified, if necessary, to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

What is claimed is:

1. A data analysis method comprising:
assessing a source memory device by an intermediate computing device;
copying data from the source memory device to a destination memory device;
copying data from the source memory device to the intermediate computing device;
monitoring the copying of the data to the intermediate device to determine if partitions can be read;
based on if the partitions can be read, monitoring the copying of the data to the intermediate device to determine if an end of a file can be read; and
based on if the end of a file can be read, extracting files of interest from the data copied onto the intermediate computing device.

2. The data analysis method of claim 1, wherein the assessing of the source memory device comprises:
assessing a partition table of the source memory device.

3. The data analysis method of claim 1, wherein the assessing of the source memory device comprises:
identifying a plurality of files based on pre-specified criteria.

4. The data analysis method of claim 3, further comprises:
Identifying a memory address corresponding to each of the plurality of identified files.

5. The data analysis method of claim 1, wherein the data from the source memory device is copied to the destination memory device concurrently with the copying of the data from the source memory device to the intermediate computing device.

6. The data analysis method of claim 1, wherein the end of the file that can be read is a file of interest.

7. The data analysis method of claim 1, further comprising:
continuing monitoring the copying of the data to the intermediate device if partitions cannot be read.

8. The data analysis method of claim 1, further comprising:
continuing monitoring the copying of the data to the intermediate device if the end of a file cannot be read.

9. The data analysis method of claim 1, further comprising:
copying data from the source memory device to each of a plurality of intermediate computing devices.

10. The data analysis method of claim 1, wherein the data is copied from the source memory device to the destination device via the intermediate computing device.

11. The data analysis method of claim 1, wherein the extracted files are stored in the destination memory device.

12. A system for analyzing data, comprising:
a source memory device including a plurality of data files;
an intermediate computing device communicatively coupled to the source memory device; and
a destination memory device communicatively coupled to the intermediate computing device, wherein the intermediate computing device
assesses a structure of the source memory device;
initiates a copying of the data from the source memory device to the destination memory device; and
initiates a copying of the data from the source memory device to the intermediate computing device concurrently with the copying of the data to the destination computing device.

13. The system of claim 12, wherein the data is copied from the source memory device to the destination memory device via the intermediate computing device.

14. The system of claim 13, wherein the extracted files are stored in the destination memory device.
